(19) United States
(12) Patent Application Publication
(10) Pub. No.: US 2004/0002234 A1
(43) Pub. Date: Jan. 1, 2004

(54) Land grid array connector with canted electrical terminals

(76) Inventors: Okita Masao, Furukawa (JP); Ming-Lun Szu, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/289,583

(22) Filed: Nov. 6, 2002

(30) Foreign Application Priority Data
Jun. 28, 2002 (TW) 91209762

(51) Int. Cl. H01R 12/00

(52) U.S. Cl. 439/66

(57) ABSTRACT

An electrical connector (3) for electrical interconnection of a pair of circuit substrates (5, 6) includes a carrier plate (7) defining a plurality of openings (71) retaining electrical terminals (4) therein. The openings correspond to circuit pads (51, 61) on the circuit substrates. Each terminal generally has a canted coil spring configuration. Each loop of the canted coil spring configuration has curved contact portions (41, 42) for bearing against corresponding circuit pads, engaging portions (43) for engaging side walls of the carrier plate at a corresponding opening, and connection portions interconnecting the curved contact portions and the engaging portions. Radiuses of curvature of the curved contact portions are less than radiuses of curvature of the connection portions of each loop. Each loop closely abuts an adjacent loop of the terminal. Relatively large contact normal force is thus attained when the curved contact portions bear against the corresponding circuit pads.

### BACKGROUND OF THE INVENTION

1. Field of the Invention

The present invention relates to an electrical connector such as a land grid array (LGA) connector having canted electrical terminals for electrically interconnecting two spaced apart circuit substrates.

2. Description of Related Art

Electrical connectors for electrically interconnecting two circuit substrates have been devised since as early as July, 1970. For example, U.S. Pat. No. 3,638,163 granted to Loosme disclosed a cylindrical, insulative body having a multiplicity of spaced apart conductive contacts wrapped therearound for being placed between parallel substrates having conductive strips thereon. The strips were thereby electrically interconnected through the contacts.

Subsequently, U.S. Pat. No. 3,795,884 granted to Y. Kotaka disclosed a connector comprising an insulative block having coil springs encapsulated therein. Each coil was electrically isolated from adjacent coils by an axial cut in one surface of the block. The coils extended outwardly from diametric surfaces of the block to engage conductors on parallel printed circuit boards.

Thereafter, on Oct. 12, 1976, U.S. Pat. No. 3,985,413 was granted to W. R. Evans. This patent disclosed an electrical connector comprising a generally cylindrical elastomeric body having a thin non-yielding flexible circuit wrapped therearound. The connector was placed between two parallel circuit substrates that were compressed. Thus corresponding conductors on the circuit substrates were electrically connected by the conductors on the flexible circuit.

In 1987, U.S. Pat. No. 4,655,462 was granted to P. J. Balsells. This patent discloses a coil spring, with each coil being disposed at a pre-selected acute angle relative to the centerline of the spring. This type of coil spring, referred to as a “canted” coil spring, exerts a constant force in a loading direction normal to the centerline over a substantial range of deflection. These types of springs can be used as electrical paths through which corresponding circuit pads on respective spaced apart circuit substrates are connected.

On Jul. 9, 1991, U.S. Pat. No. 5,030,109 was granted to Ronald A. Dery. This patent discloses an area array connector comprising a carrier plate having canted coil spring contacts positioned in openings for electrically interconnecting corresponding circuit pads on respective substrates between which the connector is placed. In use, the connector is placed between the substrates, with the spring contacts loosely connecting with the corresponding circuit pads. The two substrates are then secured together by, say, bolts, so that compressive force is applied to the spring contacts. As this occurs, the spring contacts move in the direction of the cant and thereby wipe the respective circuit pads.

However, each of the contacts is substantially a coiled spring. Due to this configuration, contact normal force acting on the mating interface between the contact and the circuit pad is generally not large enough to maintain a reliable connection therebetween. This is especially so when the connector is used in harsh environments in which corrosion and contaminants degenerate the mating interface. As explained in chapter 6.2 of “Electronic Connector Handbook” edited by Robert S. Mroczkowski, “Increasing normal force increases friction forces, and therefore mating forces, and also wear rates. The mitigating factor is that increased friction force also increases the mechanical stability of the contact interface. This is a positive effect in that it reduces the potential for disturbance of the interface and, therefore, the sensitivity of the connector to corrosion products and contaminants that may be present at or near the contact interface.”

In view of the above, an LGA connector with improved electrical terminals that overcomes the above-mentioned disadvantages is desired.

### SUMMARY OF THE INVENTION

Accordingly, an object of the present invention is to provide an electrical connector with improved electrical terminals for electrically interconnection two spaced apart circuit substrates such that relative large contact normal force is attained.

To achieve the above-mentioned object, an electrical connector in accordance with the present invention for electrical interconnection of a pair of circuit substrates comprises a carrier plate defining a plurality of openings retaining electrical terminals therein. The openings are arranged in a pattern corresponding to a pattern of circuit pads on the circuit substrates. The carrier plate is adapted to be positioned between the circuit substrates. Each terminal generally has a canted coil spring configuration. Each loop of the canted coil spring configuration has curved contact portions for bearing against corresponding circuit pads of the respective circuit substrates, engaging portions for engaging side walls of the carrier plate at a corresponding opening, and connection portions interconnecting the contact portions and the engaging portions. Radiuses of curvature of the curved contact portions are less than radiuses of curvature of the connection portions of each loop. Each loop closely abuts an adjacent loop of the terminal. Relatively large contact normal force is thus attained when the curved contact portions bear against the corresponding circuit pads.

Other objects, advantages and novel features of the present invention will become more apparent from the following detailed description when taken in conjunction with the accompanying drawings, in which:

### BRIEF DESCRIPTION OF THE DRAWINGS

FIG. 1 is an exploded isometric view of an electrical connector in accordance with a preferred embodiment of the present invention together with a pair of spaced apart circuit substrates, the connector comprising a carrier plate defining openings retaining electrical terminals, the circuit substrates respectively comprising circuit pads;

FIG. 2 is an enlarged isometric view of one terminal of the connector of FIG. 1; and

FIG. 3 is a cross-sectional view of corresponding portions of the connector and circuit substrates of FIG. 1 connected together, showing the circuit pads of the respective circuit substrates being electrically interconnected by the terminals of the carrier plate.

### DETAILED DESCRIPTION OF PREFERRED EMBODIMENT OF THE INVENTION

Reference will now be made to the drawings to describe the present invention in detail.

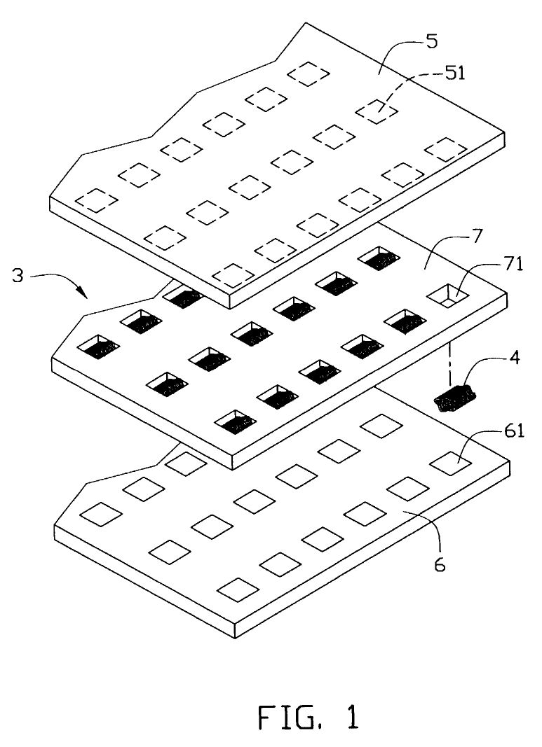

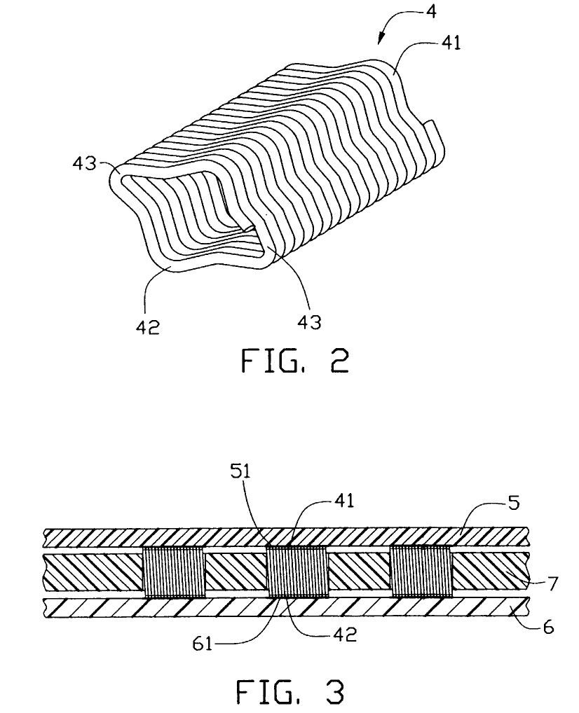

Referring to FIGS. 1 and 2, an electrical connector 3 in accordance with a preferred embodiment of the present invention comprises a carrier plate 7 having a multiplicity of openings 71 defined therethrough, and a multiplicity of canted coil spring electrical terminals 4 respectively received in the openings 71.

The carrier plate 7 may be of any suitable insulative material. Alternatively, if the carrier plate 7 is formed from a conductive material such as steel, the conductive material must coated with an insulative layer. The openings 71 of the preferred embodiment are square openings. The openings 71 may alternatively have another shape; for example, they may be rectangular openings. A shape and size of the openings 71 correspond to a shape and size of circuit pads 51, 61 of respective circuit substrates 5, 6.

Each terminal 4 is cut from a length of electrically conductive, resilient, rod-like material such as beryllium copper, and plated with gold or another noble metal. The rod-like material is then coiled and deformed to form the canted coil spring configuration of the terminal 4. Each loop of the canted coil spring configuration of the terminal 4 comprises a first curved contact portion 41 having a first radius of curvature, and an opposite second curved contact portion 42 having a second radius of curvature that is the same as the first radius of curvature of first curved contact portion 41. The first and second curved contact portions 41, 42 are for directly bearing against the respective circuit pads 51, 61. Each said loop further comprises a pair of opposite engaging portions 43 each having a third radius of curvature, for engaging with respective side walls (not labeled) of the carrier plate 7 at the corresponding opening 71. The third radius of curvature of each engaging portion 43 is substantially the same as the first and second radiuses of curvature of the first and second curved contact portions 41, 42. Each said loop also comprises connection portions (not labeled) interconnecting the first and second curved contact portions 41, 42 with the engaging portions 43. Each connection portion has a fourth radius of curvature, which is greater than the first, second and third radiuses of curvature of the first and second curved contact portions 41, 42 and engaging portions 43. Each said loop closely abuts an adjacent loop of the terminal 4. Thus the terminal 4 is coiled and formed generally as a coil spring having a substantially diamond-shaped profile.

Referring to FIG. 3, in use, the connector 3 is sandwiched between the circuit substrates 5, 6. The terminals 4 are positioned between the respective circuit pads 51, 61 to electrically interconnect the respective circuit substrates 5, 6. The circuit substrates 5, 6 are compressingly secured together, and compressive force is applied to the terminals 4. Because said loops of each terminal 4 closely abut each other, and because the first and second radiuses of curvature of the first and second curved contact portions 41, 42 are relatively small, relatively large contact normal force is attained where the first and second curved contact portions 41, 42 bear against the circuit pads 51, 61. Such force is large enough to ensure reliable electrical connection between the connector 3 and the circuit substrates 5, 6, even when the connector 3 is used in harsh environments.

While a preferred embodiment in accordance with the present invention has been shown and described, equivalent modifications and changes known to persons skilled in the art according to the spirit of the present invention are considered within the scope of the present invention as defined in the appended claims.

What is claimed is:

1. An electrical connector for electrically interconnecting circuit pads on two spaced apart circuit substrates, the electrical connector comprising:
a carrier plate defining a plurality of openings therethrough, the openings being arranged in a pattern corresponding to a pattern of the circuit pads on the circuit substrates, the carrier plate being adapted to be positioned between the circuit substrates; and
a plurality of terminals received in the openings of the carrier plate, each of the terminals having curved contact portions for bearing against corresponding circuit pads, engaging portions for engaging side walls of the carrier plate at a corresponding opening, and connection portions interconnecting the contact portions and the engaging portions;
wherein radiuses of curvature of the curved contact portions are less than radiuses of curvature of the connection portions of each of the terminals, whereby relatively large contact normal force can be attained when the curved contact portions bear against the corresponding circuit pads.

2. The electrical connector as claimed in claim 1, wherein radiuses of curvature of the engaging portions are substantially the same as radiuses of curvature of the curved contact portions of each of the terminals.

3. The electrical connector as claimed in claim 2, wherein each of the terminals generally has a canted coil spring configuration and comprises a plurality of adjacent loops closely abutting each other.

4. An electrical connector comprising:
an insulative planar body defining opposite upper and lower faces with a plurality of through holes therethrough;
a plurality of terminals received in the corresponding through holes, respectively; and
each of said terminals including two opposite curved contact portions extending out of the upper and lower faces, respectively, two opposite curved engaging portions between said two opposite curved contact portions and engaged with corresponding walls in the corresponding through hole, a connection portion defined between every adjacent two contact portion and engaging portion; wherein
a radius of said curved contact portion is less than that of curvature of the connection portion so as to result in a larger contact normal force when said contact portion experiences a vertical force along a vertical direction of the corresponding through hole.

5. The connector as claimed in claim 4, wherein each of said terminals includes more than one turns.

6. An electrical connector comprising:
upper and lower plates with conductors thereon;
an insulative planar body sandwiched between said upper and lower plates and defining opposite upper and lower faces confronting said upper and lower plates, respectively,
a plurality of through holes extending through the body and reaching said upper and lower faces;
a plurality of terminals received in the corresponding through holes, respectively; and
each of said terminals formed by a spring wire with plural turns, each turn being not of a round shape and including two opposite curved contact portions extending out of the upper and lower faces and engaged with the corresponding conductors on the upper and lower plates, respectively, two connection portions joined on two sides of each of said contact portions; wherein
a radius of said curved contact portion is less than that of curvature of the connection portion so as to result in a larger contact normal force when said terminal is deflected by said upper and lower plates on said opposite contact portions.
